(19) United States
(12) Patent Application Publication
(10) Pub. No.: US 2019/0299406 A1
(43) Pub. Date: Oct. 3, 2019

(54) CONTROLLER AND MACHINE LEARNING DEVICE

(71) Applicant: Fanuc Corporation, Yamanashi (JP)

(72) Inventor: Yuuki Kurokawa, Minamitsuru-gun (JP)

(73) Assignee: Fanuc Corporation, Yamanashi (JP)

(21) Appl. No.: 16/367,659

(22) Filed: Mar. 28, 2019

(30) Foreign Application Priority Data
Apr. 2, 2018 (JP) 2018-071021

(51) Int. Cl. B25J 9/16; B25J 13/00; B25J 11/00

(52) U.S. Cl. CPC B25J 9/163; B25J 11/006; B25J 13/006

(57) ABSTRACT

A controller includes a machine learning device for learning machining conditions when deburring is performed by controlling the robot. The machine learning device observes workpiece information indicating a shape or material of a workpiece, burr information indicating a shape or position of a burr, and machining conditions including tool information indicating a type of a tool, a feed rate of the tool and a rotational speed of the tool, as a state variable representing a current state of an environment, and acquires determination data indicating an evaluation result of the deburring. Then, using the observed state variable and the acquired determination data, the machine learning device performs learning by associating the machining conditions with the workpiece information and the burr information.

### RELATED APPLICATIONS

The present application claims priority to Japanese Patent Application Number 2018-071021 filed Apr. 2, 2018, the disclosure of which is hereby incorporated by reference herein in its entirety.

### BACKGROUND OF THE INVENTION

### 1. Field of the Invention

The present invention relates to a controller and a machine learning device, and more particularly to a controller and a machine learning device for optimizing machining conditions in deburring.

### 2. Description of the Related Art

Machining for removing a burr generated by machining a workpiece is referred to as deburring. For example, as illustrated in FIG. 9, a burr that is being generated in the workpiece 4 is recognized by a vision sensor 5, and deburring is performed by grinding a burr using a tool 8 attached to an arm 7 of a robot 6.

Various methods of automating deburring have been proposed. For example, Japanese Patent Application Laid-Open No. 07-104829 discloses a method of automating deburring, in which a burr formation state of a workpiece to be deburred is detected by visual sensor means, a deburring tool to be used is selected by collating the detection results with preset machining condition selection criteria, the selected deburring tool is mounted on a robot using an auto-changer, and the robot having the deburring tool mounted thereon is moved by a reproduction operation of a teaching program to execute deburring.

According to the method disclosed in the aforementioned Japanese Patent Application Laid-Open No. 07-104829, it is necessary for an operator to set machining conditions in advance, and there is a problem that much labor and time are required for the setting operation. This problem will be described below with reference to FIG. 10.

For example, an operator selects and sets a type of the tool 8 to be used for deburring, for example, based on the operator's experience, according to a material of the workpiece 4 and a size and shape of a burr 9, in the related art. For example, in a case where the material of the workpiece 4 is hard (stainless steel or the like) and in a case where the burr 9 is large, a tool 8 having a relatively high grinding force is selected for the burr 9 in a longitudinal direction (Z direction in FIG. 10). On the other hand, in a case where the material of the workpiece 4 is soft (aluminum or the like) and in a case where the burr 9 is small, a tool 8 having a relatively low grinding force is selected for the burr 9 in a lateral direction (X direction in FIG. 10).

It has been known that, once the type of the tool is determined, it is possible to determine machining conditions such as a cutting amount, a rotational speed of the tool, a feed rate of the tool and the like to some extent.

FIG. 11 is a table illustrating the cutting amount for each type of a tool, the rotational speed of the tool, and a recommended value of the feed rate of the tool.

However, even though the tool selected based on the experience is used based on recommended values, there are some cases where it is impossible to successfully remove the burr. In the related art, in such cases, the burr has been removed through trial and error manner by means of increasing the rotational speed to the upper limit, decreasing the feed rate, or replacing the tool with another tool having a high grinding force, or the like. Operations through such trial and error manner have also required a lot of time and effort.

### SUMMARY OF THE INVENTION

The present invention has been made to solve such problems, and an object of the present invention is to provide a controller and a machine learning device for optimizing machining conditions in deburring.

A controller according to a mode of the present invention controls a robot performing deburring for removing a burr from a workpiece and includes a machine learning device for learning machining conditions when the deburring is performed. The machine learning device includes a state observing unit for observing workpiece information indicating at least one of a shape or a material of the workpiece, burr information indicating at least one of a shape or a position of the burr, and machining conditions including tool information indicating a type of a tool, a feed rate of the tool and a rotational speed of the tool, as a state variable representing a current state of an environment; a determination data acquiring unit for acquiring determination data indicating an evaluation result of the deburring; and a learning unit for performing learning by associating the machining conditions with the workpiece information and the burr information, using the state variable and the determination data.

The determination data may include at least one of a removal rate of the burr or a cycle time of the deburring.

The learning unit may include: a reward calculating unit for obtaining a reward related to the evaluation result; and a value function updating unit for updating a function representing values of the machining conditions with respect to the workpiece information and the burr information using the reward.

The learning unit may calculate the state variable and the determination data with a multilayered structure.

The controller may further include a decision making unit for outputting a command value based on the machining conditions, based on a learning result by the learning unit.

The learning unit may learn the machining conditions using the state variable and the determination data obtained from a plurality of the robots.

The machine learning device may be implemented by cloud computing, fog computing, and edge computing environment.

A machine learning device according to a mode of the present invention learns machining conditions when a robot performs the deburring for removing a burr from a workpiece and includes: a state observing unit for observing workpiece information indicating at least one of a shape or a material of the workpiece, burr information indicating at least one of a shape or a position of the burr, and machining conditions including tool information indicating a type of a tool, a feed rate of the tool and a rotational speed of the tool, as a state variable representing a current state of an environment; a determination data acquiring unit for acquiring determination data indicating an evaluation result of the deburring; and a learning unit for performing learning by associating the machining conditions with the workpiece information and the burr information, using the state variable and the determination data.

According to the present invention, it is possible to provide a controller and a machine learning device for optimizing machining conditions in deburring.

### BRIEF DESCRIPTION OF THE DRAWINGS

FIG. 1 is a schematic hardware configuration diagram of a controller according to a first embodiment;

FIG. 2 is a schematic functional block diagram of the controller of FIG. 1;

FIG. 3 is a schematic functional block diagram illustrating one embodiment of the controller;

FIG. 4 is a schematic flow chart illustrating one embodiment of a machine learning method;

FIG. 5A is a diagram for describing a neuron;

FIG. 5B is a diagram for describing a neural network;

FIG. 6 is a schematic functional block diagram of a controller according to a second embodiment;

FIG. 7 is a schematic functional block diagram illustrating one embodiment of a system incorporating controllers;

FIG. 8 is a schematic functional block diagram illustrating another embodiment of the system incorporating the controllers;

FIG. 9 is a schematic diagram of the deburring;

FIG. 10 is a schematic view of the deburring; and

FIG. 11 illustrates an example of recommended values of machining conditions used in the deburring of the related art.

### DETAILED DESCRIPTION OF THE PREFERRED EMBODIMENTS

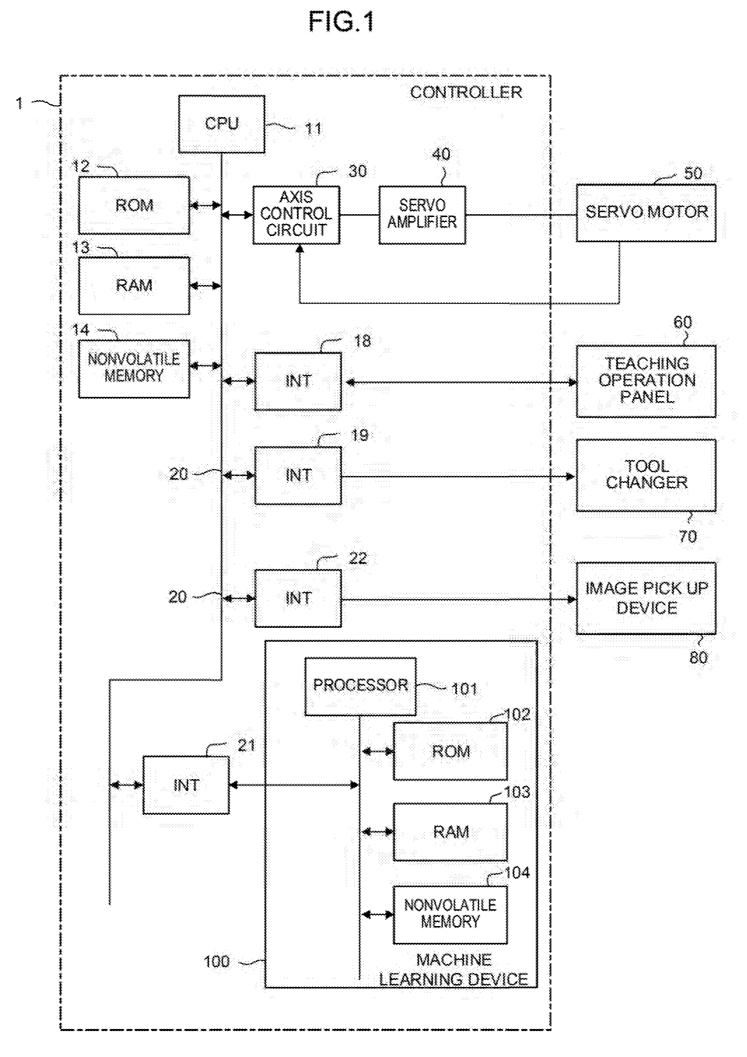

FIG. 1 is a schematic hardware configuration diagram illustrating a controller 1 according to a first embodiment and main units of an industrial machine controlled by the controller 1.

The controller 1 is, for example, a controller for controlling an industrial robot, a machining center or the like (hereinafter, simply referred to as a robot) performing deburring. The controller 1 includes a CPU 11, a ROM 12, a RAM 13, a nonvolatile memory 14, an interface 18, an interface 19, an interface 21, an interface 22, a bus 20, an axis control circuit 30, and a servo amplifier 40. A servo motor 50, a teaching operation panel 60, a tool changer 70, and an image pickup device 80 are connected to the controller 1.

The CPU 11 is a processor that controls the controller 1 as a whole. The CPU 11 reads, through the interface 22 and the bus 20, a system program stored in the ROM 12, and controls the entire controller 1 according to the system program.

In advance, the ROM 12 stores the system program (including a system program for controlling interaction with a machine learning device 100 described later) for executing various control of the robot and the like.

The RAM 13 temporarily stores temporary calculation data and display data, data input by an operator through the teaching operation panel 60 (described later), and the like.

The nonvolatile memory 14 is backed up by, for example, a battery (not illustrated), and maintains a storage state even though a power supply of the controller 1 is turned off. The nonvolatile memory 14 stores data input from the teaching operation panel 60, programs and data for controlling the robot input through an interface (not illustrated), and the like. The programs and data stored in the nonvolatile memory 14 may be developed in the RAM 13 at run time and in use.

The axis control circuit 30 controls axes of joints or the like of the robot. The axis control circuit 30 receives an amount of a movement command of an axis output from the CPU 11 and outputs the movement command of the axis to the servo amplifier 40.

The servo amplifier 40 receives a movement command of an axis output from the axis control circuit 30 and drives the servo motor 50.

The servo motor 50 is driven by the servo amplifier 40 to move the axis of the robot. A position/speed detector is typically built in the servo motor 50. Since the position/speed detector outputs a position/speed feedback signal, and this signal is fed back to the axis control circuit 30, the feedback control of the position and speed is performed.

Incidentally, in FIG. 1, only one axis control circuit 30, one servo amplifier 40, and one servo motor 50 are illustrated, but actually, these elements are provided corresponding in number to the axes of the machine tool to be controlled. For example, in a case where a robot having six axes is controlled, six sets of the axis control circuit 30, the servo amplifier 40, and the servo motor 50 corresponding to the respective axes are provided in total.

The teaching operation panel 60 is a manual data input apparatus having a display, a handle, a hardware key and the like. The teaching operation panel 60 displays information received from the CPU 11 through the interface 18 on the display. The teaching operation panel 60 delivers a pulse, a command, data and the like input from a handle, a hardware key or the like to the CPU 11 through the interface 18.

The tool changer 70 exchanges the tool supported at the tip of the arm of the robot. The tool changer 70 exchanges the tool based on a command received from the CPU 11 through the interface 19.

The image pickup device 80 is a device for taking an image of the state of the burr of a workpiece, and is, for example, a vision sensor. The image pickup device 80 captures the state of the burr of the workpiece in response to a command received from the CPU 11 through the interface 22. The image pickup device 80 delivers the image data to the CPU 11 through the interface 22.

The interface 21 is an interface for connecting the controller 1 and the machine learning device 100. The machine learning device 100 includes a processor 101, a ROM 102, a RAM 103, and a nonvolatile memory 104.

The processor 101 generally controls the entire machine learning device 100. The ROM 102 stores system programs and the like. The RAM 103 temporarily stores each processing related to machine learning. The nonvolatile memory 104 stores a learning model and the like.

The machine learning device 100 observes various types of information that is acquirable from the controller 1 (tool information in use, a feed rate of a tool, a rotational speed of the tool, image data captured by the image pickup device 80, a shape or material of workpiece, and the like) through the interface 21. The machine learning device 100 outputs a command to control the servo motor 50 and the tool changer 70 to the controller 1 through the interface 21. The controller 1 receives a command from the machine learning device 100 and corrects a control command of the robot and the like.

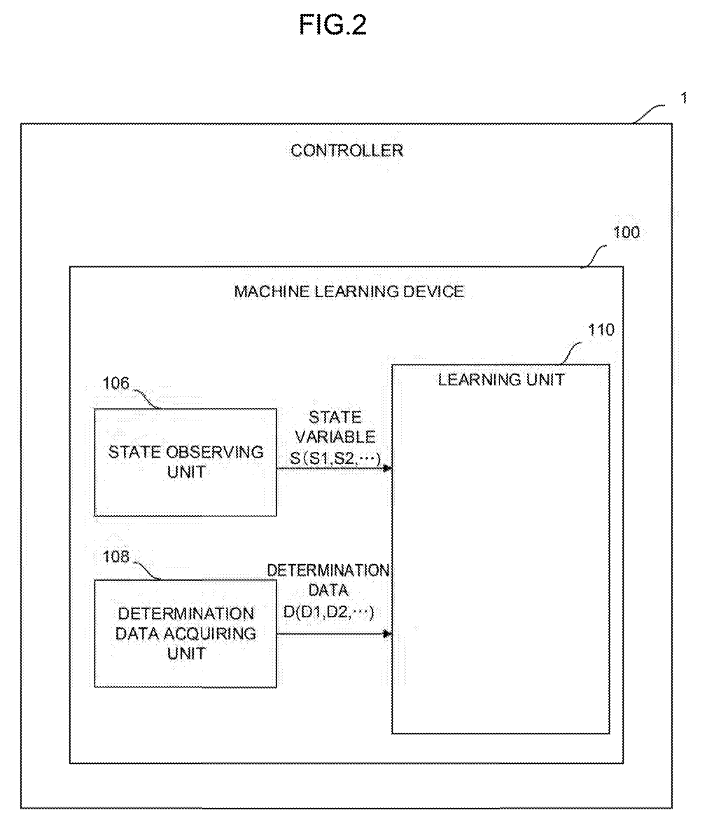

FIG. 2 is a schematic functional block diagram of the controller 1 and the machine learning device 100 in the first embodiment (FIG. 1).

The machine learning device 100 includes a state observing unit 106, a determination data acquiring unit 108, and a learning unit 110. The state observing unit 106, the determination data acquiring unit 108, and the learning unit 110 may be implemented as one function of the processor 101, for example. Alternatively, the state observing unit 106 may be implemented by allowing the processor 101 to execute software stored in the ROM 102, for example.

The state observing unit 106 observes a state variable S representing the current state of an environment. The state variable S includes workpiece information S1 related to a shape or a material of a workpiece, burr information S2 related to a position and a shape of a burr, tool information S3 indicating a type of a tool, a feed rate S4 of the tool, and a rotational speed S5 of the tool.

As the workpiece information S1, the state observing unit 106 may acquire at least one of shape information (for example, an identifier indicating the shape of a workpiece) of a workpiece being machined and material information (for example, an identifier indicating a material and the like), which are held by the controller 1.

As the burr information S2, the state observing unit 106 may acquire at least one of shape information (for example, a maximum overhang amount disclosed in the aforementioned Japanese Patent Application Laid-Open No. 07-104829) and position information (for example, an identifier indicating a surface where the burr is generated, or the like) of a burr which CPU 11 obtains by analyzing image data captured by the image pickup device 80 before the deburring.

As tool information S3, the feed rate S4 of the tool, and the rotational speed S5 of the tool, the state observing unit 106 may acquire, from the controller 1, tool information (for example, an identifier indicating the type of the tool, and the like), the feed rate of the tool and the rotational speed of the tool, which are in use during deburring.

The determination data acquiring unit 108 acquires determination data D which is an index indicating the result of performing control of the robot under the state variable S. The determination data D includes a removal rate D1 of a burr, and a cycle time D2.

As a removal rate D1 of the burr, the determination data acquiring unit 108 may use a value indicating a change amount of the shape information of the burr before and after deburring. For example, the determination data acquiring unit 108 acquires the shape information of a burr which CPU 11 obtains by analyzing the image data captured by the image pickup device 80, after performing deburring by controlling the robot under the state variable S (a maximum overhang amount Ha). The determination data acquiring unit 108 may calculate a removal rate D1=(Ha−Hb)/Ha of the burr, using the shape information (referred to as a maximum overhang amount Hb) of the burr acquired by the state observing unit 106 before deburring and the maximum overhang amount Ha after the deburring.

As the cycle time D2, the determination data acquiring unit 108 may acquire the cycle time of the deburring from the controller 1.

Using the state variable S and the determination data D, the learning unit 110 learns a correlation between a workpiece state (workpiece information S1 and burr information S2) and a machining condition (tool information S3, a feed rate S4, and a rotational speed S5). That is, the learning unit 110 generates a model structure indicating a correlation between components S1, S2, S3, S4, and S5 of the state variable S.

In terms of learning cycle in the learning unit 110, the state variable S input to the learning unit 110 is based on data during one previous learning cycle in which the determination data D is acquired. While the machine learning device 100 advances learning, in the environment,

(1) acquiring workpiece information S1 and burr information S2,

(2) setting tool information S3, the feed rate S4, and the rotational speed S5, that is, setting a machining condition,

(3) executing control of the robot according the above (1) and (2), and

(4) acquiring determination data D

are repeatedly performed. The tool information S3, the feed rate S4 and the rotational speed S5 in the above (2) are set values of the machining condition obtained based on the learning result up to the previous time. Also, the determination data D in the above (4) is the evaluation result of deburring performed based on the tool information S3, the feed rate S4, and the rotational speed S5.

By repeating such a learning cycle, the learning unit 110 may automatically identify features implying a correlation between a workpiece state (workpiece information S1 and burr information S2) and a machining condition (tool information S3, the feed rate S4, and the rotational speed S5). At the start of a learning algorithm, a correlation between a workpiece state (workpiece information S1 and burr information S2) and a machining condition (tool information S3, the feed rate S4, and the rotational speed S5) is substantially unknown, but the learning unit 110 gradually identifies the features and interprets the correlation as the learning unit 110 advances the learning.

Once the correlation between the workpiece state (workpiece information S1 and burr information S2) and the machining condition (tool information S3, the feed rate S4, and the rotational speed S5) is interpreted to a reliable level to some extent, the learning results that are iteratively output by the learning unit 110 may be used for performing a selection (making a decision) of an action such as what type of the machining condition (tool information S3, the feed rate S4, and the rotational speed S5) has to be set for the current state, that is, a workpiece state (workpiece information S1 and burr information S2). That is, the learning unit 110 may output an optimal solution of an action corresponding to the current state.

The state variable S is configured with data hardly affected by external disturbances, such as the workpiece information S1, the burr information S2, the tool information S3, the feed rate S4, and the rotational speed S5. The determination data D is uniquely obtained by acquiring the analysis result of the image data of the image pickup device 80 from the controller 1, and the cycle time. Therefore, according to the machine learning device 100, by using the learning results of the learning unit 110, it is possible to automatically and accurately obtain an optimal machining condition (tool information S3, the feed rate S4, and the rotational speed S5) for the current state, that is, a workpiece state (workpiece information S1 and burr information S2), regardless of a calculation or a rough estimation. In other words, it is possible to rapidly determine an optimal machining condition (tool information S3, the feed rate S4, and the rotational speed S5) by merely recognizing the current state, that is, the workpiece state (workpiece information S1 and burr information S2). Therefore, it is possible to efficiently set machining conditions in the deburring by the robot.

As a modified example of the machine learning device 100, using the state variable S and determination data D obtained from each of a plurality of robots performing the same operation, the learning unit 110 can learn appropriate machining conditions in the robots. According to this configuration, since it is possible to increase the number of data sets including the state variable S and the determination data D obtained during a fixed time and to input more various data sets, it is possible to improve a learning speed and reliability.

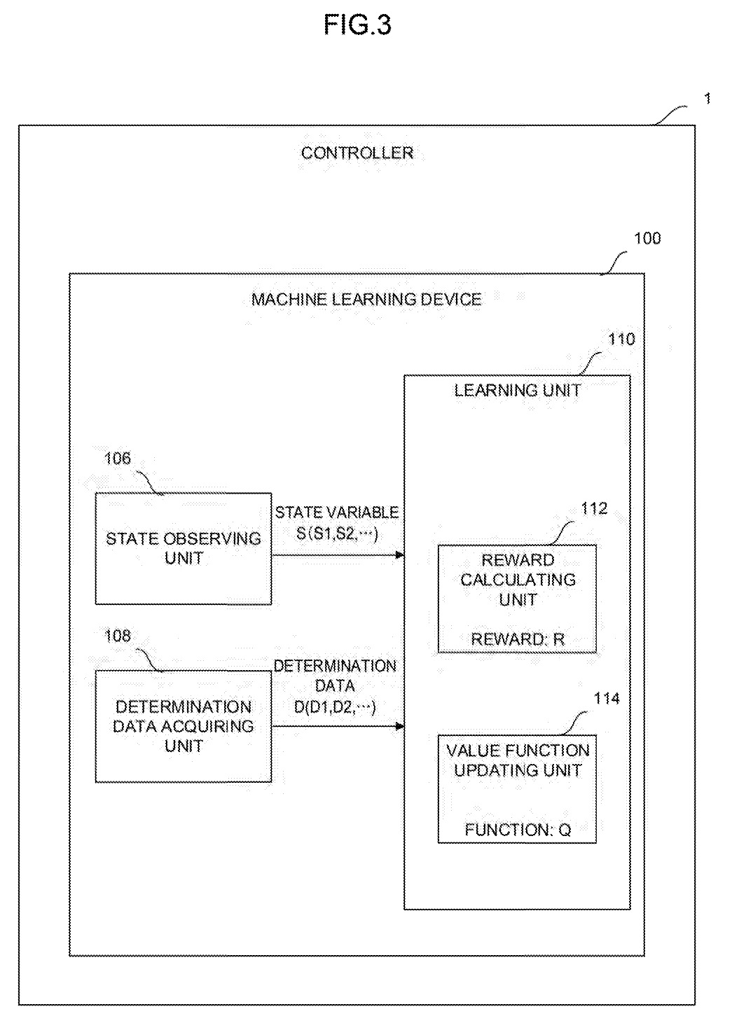

Incidentally, the learning algorithm executed by the learning unit 110 is not particularly limited thereto, and it is possible to adopt a learning algorithm known as machine learning. FIG. 3 is one embodiment of the controller 1 illustrated in FIG. 1, and illustrates a configuration such that a learning unit 110 for executing reinforcement learning is provided as an example of a learning algorithm.

The reinforcement learning is a method of learning, as an optimal solution, a strategy (setting of machining conditions in this embodiment) which repeats a cycle of observing the current state (that is, input) of the environment in which an object to be learned is provided, executing a predetermined action (that is, output) in the current state, and giving some reward to the action, through trial and error, in a manner such that the total amount of rewards are maximized.

In the machine learning device 100 included in the controller 1 illustrated in FIG. 3, the learning unit 110 includes a reward calculating unit 112 and a value function updating unit 114.

The reward calculating unit 112 obtains a reward R related to the evaluation result (corresponding to the determination data D to be used in the next learning cycle in which the state variable S is acquired) of the deburring, in a case where the machining condition is set based on the state variable S.

Using the reward R, the value function updating unit 114 updates a function Q representing a value of the machining condition. As the value function updating unit 114 repeats updating the function Q, the learning unit 110 learns a correlation between a workpiece state (workpiece information S1 and burr information S2) and a machining condition (tool information S3, the feed rate S4, and the rotational speed S5).

An example of a reinforcement learning algorithm executed by the learning unit 110 will be described.

The algorithm according to this example is known as Q learning (Q-learning), and is a method of learning a function Q(s, a) representing a value of an action in a case where the action a is selected in a state s, using the state s of an action subject and the action a selectable by the action subject in the state s, as independent variables. An optimal solution is to select an action a with which a value function Q becomes the highest in the state s. By repeating a cycle of starting Q learning in a state where a correlation between the state s and the action a is unknown, and selecting various actions a in any state s, through trial and error, the value function Q is iteratively updated and approximated to the optimal solution. Here, when the environment (that is, the state s) is changed as a result of selecting the action a in the state s, reward (that is, a weight of the action a) r corresponding to the change is configured to be obtainable, and learning is guided to select an action a in which a higher reward r is obtainable, so that it is possible to approximate the value function Q to the optimal solution in a relatively short time.

The updating equation of the value function Q may be generally represented by Equation (1) below. In Equation (1), sₜ and aₜ each are a state and an action at time t, respectively, and the state is changed into sₜ₊₁ by the action aₜ. The rₜ₊₁ is a reward obtained by changing the state from sₜ to sₜ₊₁. The term term of maxQ expresses Q in a case where an action a, by which the maximum value Q is obtained at time t+1 (which is assumed at time t), is performed. α and γ each are a learning coefficient and a discount rate and are optionally set with 0<α≤1, 0<γ≤1.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

In a case where the learning unit 110 executes the Q learning, the state variable S observed by the state observing unit 106 and the determination data D acquired by the determination data acquiring unit 108 correspond to a state s of the updating equation, and an action of how to determine the machining condition (tool information S3, the feed rate S4, and the rotational speed S5) with respect to a current state, that is, a workpiece state (workpiece information S1 and burr information S2) corresponds to the action a of the updating equation, and the reward R obtained by the reward calculating unit 112 corresponds to the reward r of the updating equation. Therefore, the value function updating unit 114 repeatedly updates the function Q representing a set value of a machining condition with respect to the current state, by Q learning using the reward R.

For example, the reward calculating unit 112 performs deburring based on the determined machining condition (tool information S3, the feed rate S4, and rotational speed S5), and in a case where the evaluation result of the deburring process is determined to be “appropriate”, it is possible to set reward R to a positive (plus) value. On the other hand, in a case where the evaluation result of the deburring is determined to be “inappropriate”, it is possible to set the reward R to a negative (minus) value. The absolute values of the positive and negative rewards R may be the same to each other or different from each other.

As a case where the evaluation result of deburring is “appropriate”, there is, for example, a case where the removal rate D1 of the burr is equal to or more than a predetermined threshold value and the cycle time D2 is less than a predetermined threshold value. On the other hand, as a case where the evaluation result of the deburring is “inappropriate”, there is, for example, a case where the removal rate D1 of the burr is less than a predetermined threshold value and the cycle time D2 is equal to or more than a predetermined threshold value. Incidentally, the reward calculating unit 112 may determine whether the evaluation result is appropriate or inappropriate by combining a plurality of values included in the determination data D.

It is possible to set the evaluation result of deburring to a plurality of stages as well as two stages of “appropriate” or “inappropriate” stage. For example, the reward calculating unit 112 is configured to give a reward R=5 when the removal rate D1 of the burr is 0.8<D1≤1, gives a reward R=0 when 0.2<D1≤0.8, and gives a reward R=−5 when 0 D1≤0.2. Also, for example, the reward calculating unit 112 is configured to give a reward R=5 when a relation between the cycle time D2 and a target value T is T≤D2, gives a reward R=0 when 0.8T≤D2<T, and gives a reward R=−5 when D2<0.8T.

The value function updating unit 114 can have an action value table organized by associating the state variable S, the determination data D, and the reward R with the action value (for example, a numerical value) represented by the function Q. In this case, the action of updating the function Q by the value function updating unit 114 is synonymous with the action of updating the action value table by the value function updating unit 114. Since a correlation between a workpiece state (workpiece information S1 and burr information S2) and a machining condition (tool information S3, the feed rate S4, and the rotational speed S5) is unknown at the start of Q learning, in the action value table, a variety of state variables S, determination data D and rewards R are provided in a form in association with randomly determined values of the action value (function Q). In a case where the determination data D is known, the reward calculating unit 112 can immediately calculate the corresponding reward R, and the calculated value R is written in the action value table.

When advancing Q learning using the reward R corresponding to the evaluation result of the deburring, the learning is guided in a direction of selecting an action in which a higher reward R is obtainable, and the action value table is updated by rewriting a value (function Q) of the action value for the action to be performed in the current state, according to a state of the environment which is changed as a result of executing the selected action in the current state (that is, the state variable S and the determination data D). By repeating this updating, it is possible to rewrite the value (function Q) of the action value displayed in the action value table into a larger value as the action is more appropriate. In this way, a correlation between a unknown current state of the environment, that is, a workpiece state (the workpiece information S1 and the burr information S2), and an action corresponding to the workpiece state, that is, a set machining condition (the tool information S3, the feed rate S4, and the rotational speed S5) gradually is made clear. That is, by updating the action value table, the correlation between the workpiece state (workpiece information S1 and burr information S2) and the machining condition (tool information S3, the feed rate S4, and the rotational speed S5) gradually approaches the optimal solution.

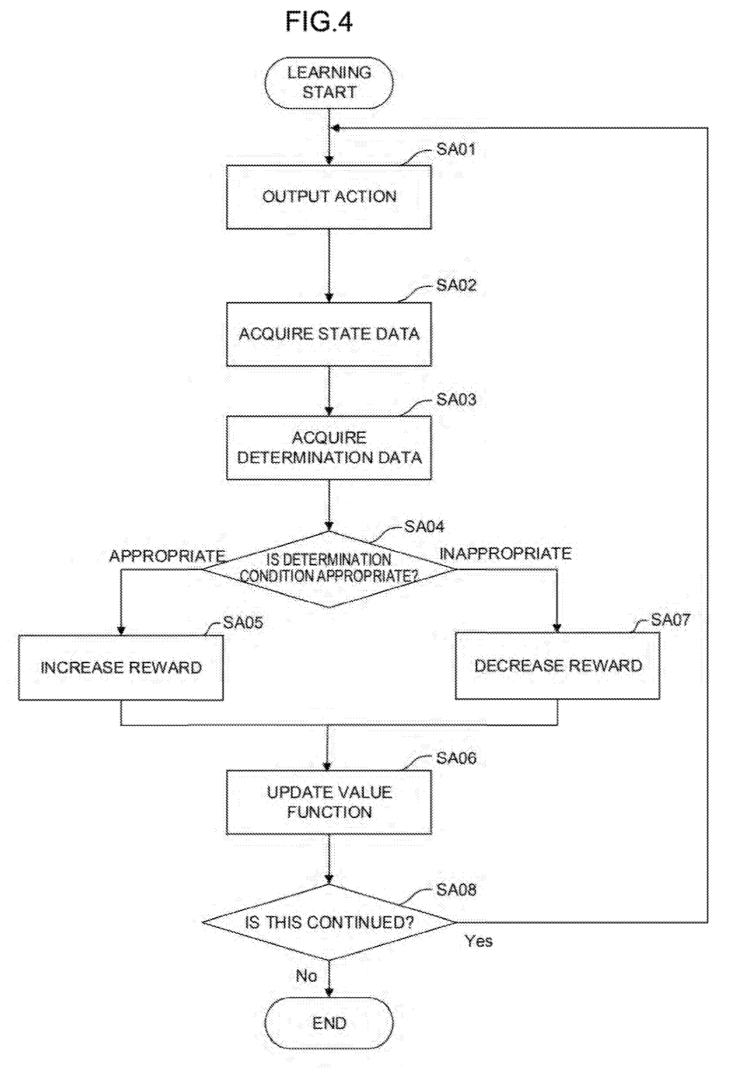

Referring to FIG. 4, the flow of Q learning executed by the learning unit 110 (that is, one embodiment of the machine learning method) will be further described.

Step SA01: Referring to the action value table at that time, the value function updating unit 114 randomly selects a machining condition (tool information S3, the feed rate S4, and the rotational speed S5) as an action to be performed in the current state indicated by the state variable S observed by the state observing unit 106.

Step SA02: The value function updating unit 114 fetches the state variable S of the current state observed by the state observing unit 106.

Step SA03: The value function updating unit 114 fetches the determination data D of the current state acquired by the determination data acquiring unit 108.

Step SA04: Based on the determination data D, the value function updating unit 114 determines whether the machining condition (the tool information S3, the feed rate S4, and the rotational speed S5) is appropriate or inappropriate. In a case where the machining condition is appropriate, the machining proceeds to step SA05. In a case where the machining condition is inappropriate, the machining proceeds to step SA07.

Step SA05: The value function updating unit 114 applies a positive reward R obtained by the reward calculating unit 112 to the updating equation of the function Q.

Step SA06: The value function updating unit 114 updates the action value table using the state variable S and the determination data D in the current state, the reward R, and the value of the action value (updated function Q).

Step SA07: The value function updating unit 114 applies a negative reward R obtained by the reward calculating unit 112 to the updating equation of the function Q.

The learning unit 110 iteratively updates the action value table by repeating the processing of steps SA01 to SA07, and causes the learning to proceed. Incidentally, the processing of obtaining the reward R and the processing of updating the value function from the step SA04 to the step SA07 are performed on each data included in the determination data D.

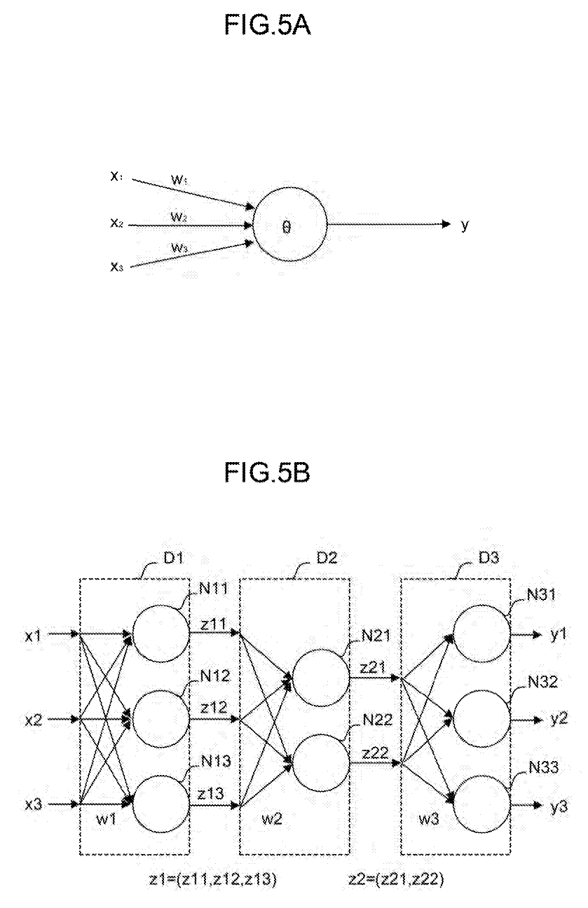

When advancing reinforcement learning, for example, it is possible to use a neural network, instead of Q learning. FIG. 5A schematically illustrates a neuron model. FIG. 5B schematically illustrates a model of a three-layer neural network configured by combining neurons illustrated in FIG. 5A. For example, the neural network is configurable with an arithmetic device imitating a model of a neuron, a storage device, or the like.

The neuron as illustrated in FIG. 5A outputs a result y for a plurality of inputs x (herein, inputs x₁ to x₃, as an example). Each of the inputs x₁ to x₃ is multiplied by weights w (w₁ to w₃) respectively corresponding to this input x. As a result, the neuron outputs the result y represented by Equation (2) below. Incidentally, in Equation (2), the input x, the result y and the weight w are all vectors. Also, θ is a bias, and fₖ is an activation function.

y=fₖ(Σᵢ₌₁ⁿxᵢwᵢ−θ) (2)

In the three-layered neural network illustrated in FIG. 5B, a plurality of inputs x (here, inputs x1 to x3 as an example) are input from the left side and the result y (herein, results y1 to y3, as an example) is output from the right side. In the illustrated example, each of inputs x1, x2, and x3 is multiplied by a corresponding weight (collectively represented as w1), and each of the inputs x1, x2, and x3 is input to three neurons N11, N12, and N13.

In FIG. 5B, the outputs of each of the neurons N11 to N13 are collectively represented as z1. The z1 may be regarded as a feature vector from which feature quantities of input vectors are extracted. In the illustrated example, each of elements of the feature vector z1 is multiplied by a corresponding weight (represented collectively as w2), and each of the individual elements of the feature vector z1 is input to two neurons N21 and N22. The feature vector z1 represents a feature between the weight W1 and the weight W2.

Also, the outputs of the neurons N21 to N22 are collectively represented as z2. The z2 may be regarded as a feature vector from which the feature quantities of the feature vector z1 are extracted. In the illustrated example, each of elements of the feature vectors z2 is multiplied by a corresponding weight (represented collectively as w3), and each of the individual elements of the feature vector z2 is input to three neurons N31, N32, and N33. The feature vector z2 represents a feature between the weight W2 and the weight W3. Finally, the neurons N31 to N33 output results y1 to y3, respectively.

Incidentally, it is also possible to use a so-called deep learning method using a neural network with three or more layers.

In the machine learning device 100, using the state variable S and the determination data D as the input x, the learning unit 110 performs calculation on a multilayered structure according to the neural network, so that it is possible to output the machining condition (the tool information S3, the feed rate S4, and the rotational speed S5) as the result y. Also, in the machine learning device 100, using the neural network as a value function in the reinforcement learning and using the state variable S and the action a as the input x, the learning unit 110 performs a calculation on a multilayered structure according to a neural network, so that it is also possible to output a value (result y) of a certain action corresponding to a certain state. Incidentally, an operation mode of the neural network includes a learning mode and a value prediction mode. For example, the weight w is learned using the learning data set in the learning mode, and it is possible to determine a value of an action in the value prediction mode using the learned weight w. In the value prediction mode, it is possible to perform detection, classification, inference, and the like.

The configuration of the controller 1 described above may be described as a machine learning method (or program) executed by the processor 101. This machine learning method is a machine learning method of learning machining conditions (tool information S3, a feed rate S4, and a rotational speed S5) in deburring, and includes steps of:

observing, by means of a CPU of a computer, a workpiece state (workpiece information S1 and burr information S2) as a state variable S representing a current state of an environment in which the deburring is performed;

obtaining determination data D indicating an evaluation result of the deburring performed according to a set machining condition (tool information S3, the feed rate S4, and the rotational speed S5), and

performing learning by associating a workpiece state (workpiece information S1 and burr information S2) with machining conditions (tool information S3, the feed rate S4, and the rotational speed S5), using the state variable S and the determination data D.

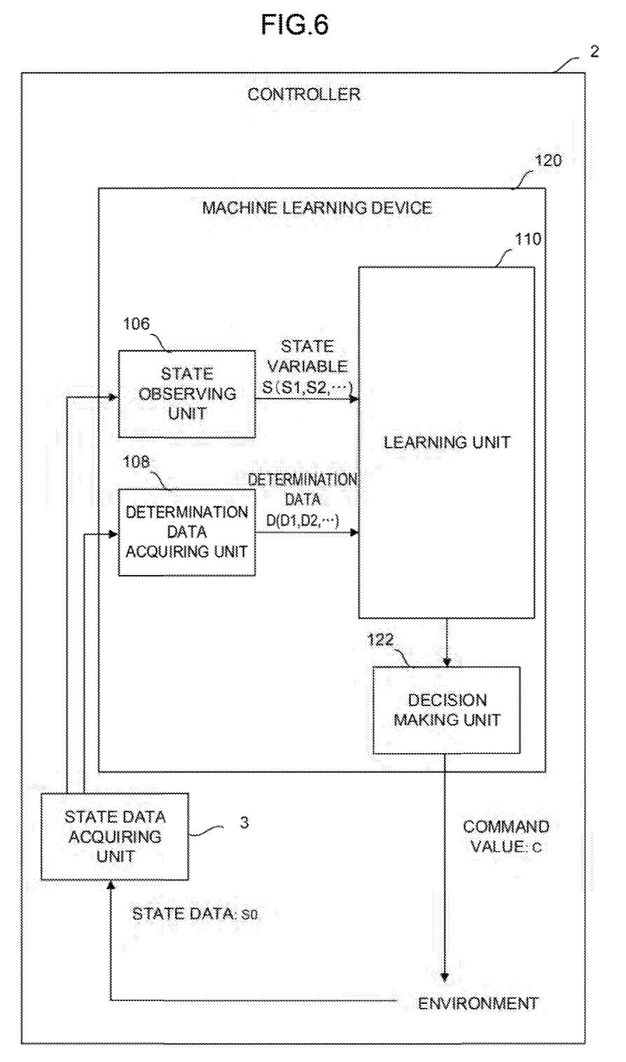

FIG. 6 illustrates a controller 2 according to a second embodiment. The controller 2 includes a machine learning device 120 and a state data acquiring unit 3.

The state data acquiring unit 3 acquires the workpiece state (workpiece information S1 and burr information S2) and the machining condition (tool information S3, the feed rate S4, and the rotational speed S5) as state data S0, and supplies the state data to the state observing unit 106. For example, the state data acquiring unit 3 may acquire the state data S0 from each unit of the controller 2, various sensors provided in the robot, data input from the teaching operation panel 60 and the like by the operator, and the like.

The machine learning device 120 includes a decision making unit 122, in addition to the state observing unit 106, the determination data acquiring unit 108, and the learning unit 110. For example, the decision making unit 122 may be implemented as one function of the processor 101, or may be implemented by the processor 101 executing software stored in the ROM 102.

In addition to software (such as a learning algorithm) and hardware (such as the processor 101) for learning machining conditions (tool information S3, the feed rate S4, and the rotational speed S5) in the deburring by its own machine learning, the machine learning device 120 includes software (such as an arithmetic algorithm) and hardware (such as the processor 101) for outputting the machining conditions (tool information S3, the feed rate S4, and the rotational speed S5) obtained based on the learning result as a command to the controller 2. The machine learning device 120 may be configured such that one common processor executes all software such as the learning algorithm and the arithmetic algorithm.

Based on the result learned by the learning unit 110, the decision making unit 122 generates a command value C including a command to determine the machining condition (tool information S3, the feed rate S4, and the rotational speed S5) corresponding to the workpiece state (workpiece information S1 and burr information S2). Once the decision making unit 122 outputs the command value C to the controller 2, the controller 2 controls the robot according to the command value C. In this way, the state of the environment is changed.

The state observing unit 106 observes the state variable S changed due to the outputting of the command value C to the environment by the decision making unit 122, in the next learning cycle. For example, the learning unit 110 learns the machining condition (tool information S3, the feed rate S4, and the rotational speed S5) in the deburring, by updating the value function Q (that is, the action value table) using the changed state variable S. Incidentally, at that time, the state observing unit 106 does not acquire a machining condition (tool information S3, the feed rate S4, and the rotational speed S5) from the state data S0 acquired by the state data acquiring unit 3, but may observe the machining condition from the RAM 103 of the machine learning device 120 as described in the first embodiment.

Then, the decision making unit 122 outputs the command value C to instruct the machining condition (the tool information S3, the feed rate S4, and the rotational speed S5) obtained based on the learning result, to the controller 2 again. By repeating this learning cycle, the machine learning device 120 advances learning and gradually improves the reliability of the machining condition (the tool information S3, the feed rate S4, and the rotational speed S5) determined by the machine learning device 120 itself.

The machine learning device 120 achieves the same effect as the machine learning device 100 of the first embodiment. In addition, the machine learning device 120 can change the state of the environment according to the output of the decision making unit 122. In the machine learning device 100, by providing an external apparatus with a function corresponding to the decision making unit 122, it is possible to reflect the learning result of the learning unit 110 on the environment.

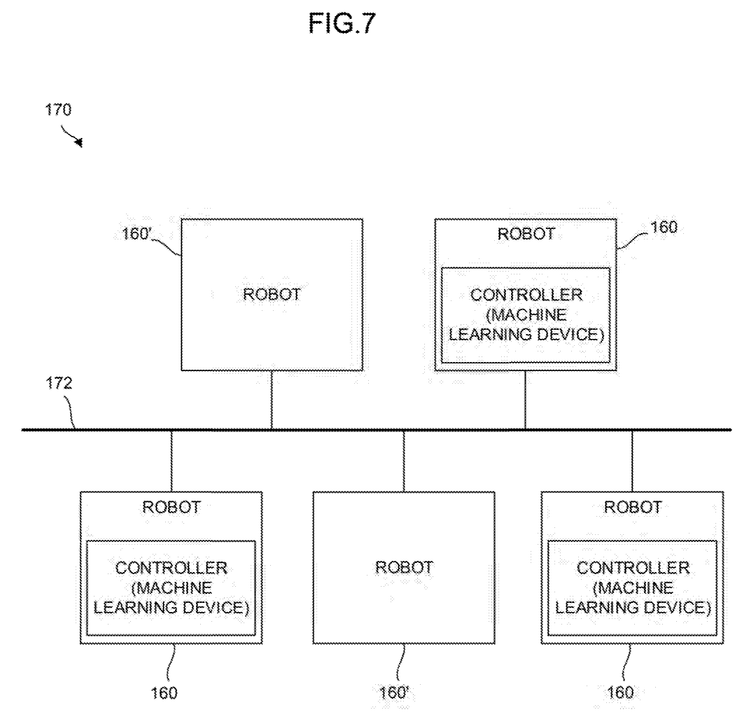

FIG. 7 illustrates a system 170 obtained by adding a plurality of robots to the controller 2.

The system 170 includes a plurality of robots 160 and robots 160′. The robot 160 and the robot 160′ have mechanisms necessary for an operation for the same purpose and perform the same operation. On the other hand, the robot 160 includes the controller 2, but the robot 160′ does not have the controller 2. All of these robots 160 and robots 160′ are connected to one another by a wired or wireless network 172.

Using the learning result of the learning unit 110, the robot 160 having the controller 2 is capable of automatically and accurately obtaining the machining condition (tool information S3, the feed rate S4, and the rotational speed S5) corresponding to the workpiece state (workpiece information S1 and burr information S2), regardless of calculation or a rough estimation. Also, using the state variable S and the determination data D obtained from each of the other plurality of robots 160 and robots 160′, the controller 2 of at least one robot 160 is configured to learn a machining condition (tool information S3, the feed rate S4, and the rotational speed S5) in the deburring, which is common to all the robots 160 and robots 160′, and to share the learning result between all robots 160 and robots 160′. According to the system 170, using more various data sets (including state variables S and determination data D) as inputs, it is possible to improve the reliability and speed of learning machining conditions (tool information S3, the feed rate S4, and the rotational speed S5) in the deburring.

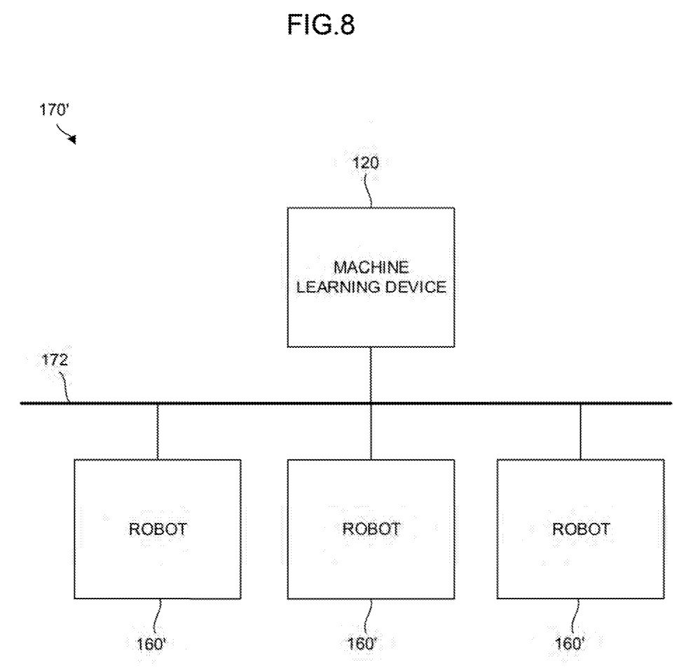

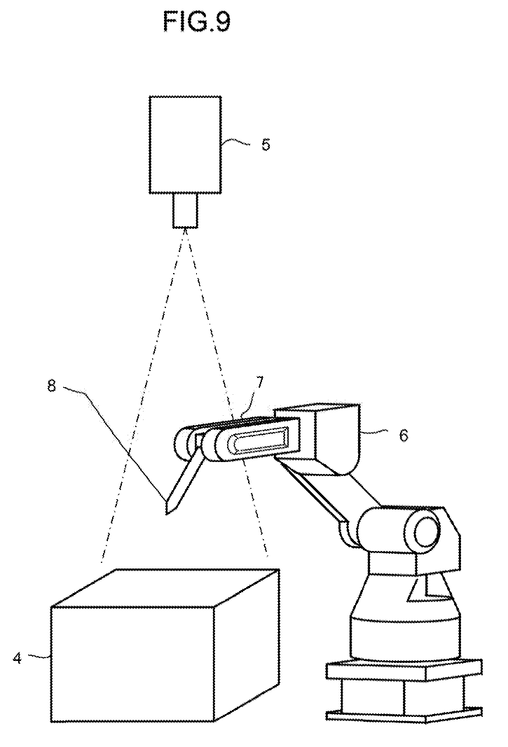

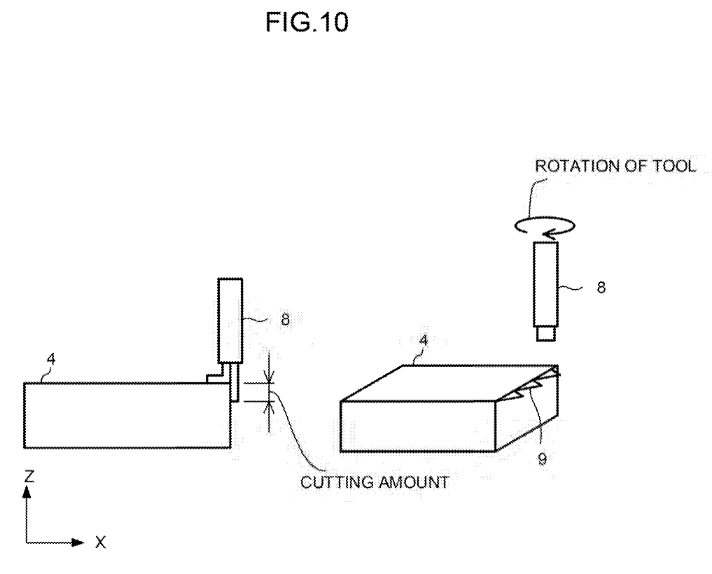

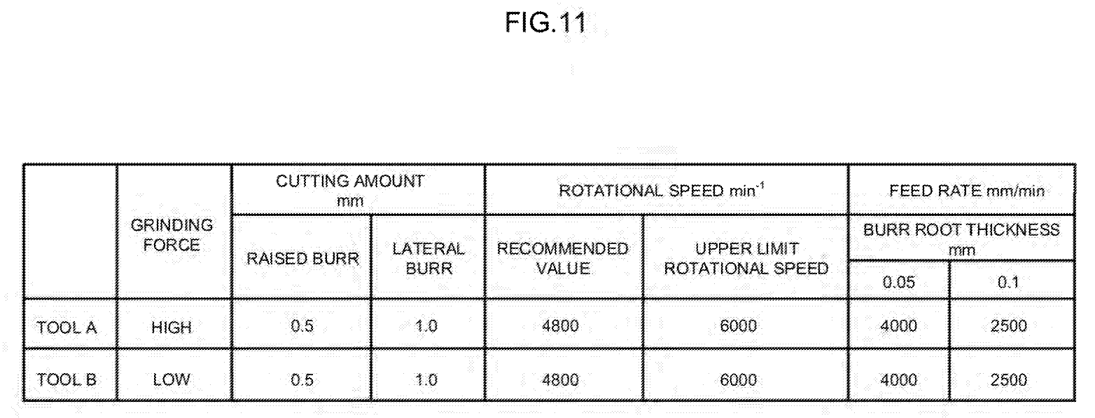

FIG. 8 illustrates a system 170′ including a plurality of robots 160′.

This system 170′ includes a machine learning device 120 (or machine learning device 100) and a plurality of robots 160′ having the same machine configuration. The plurality of robots 160′ and the machine learning device 120 (or the machine learning device 100) are connected to one another by a wired or wireless network 172.

The machine learning device 120 (or the machine learning device 100) learns machining conditions (tool information S3, the feed rate S4, and the rotational speed S5) in the deburring, which is common to all the robots 160′ based on the state variable S and the determination data D obtained from each of the plurality of robots 160′. Using the learning result, the machine learning device 120 (or the machine learning device 100) is capable of automatically and accurately obtaining the machining condition (tool information S3, the feed rate S4, and the rotational speed S5) corresponding to the workpiece state (workpiece information S1 and burr information S2), regardless of calculation or a rough estimation.

The machine learning device 120 (or the machine learning device 100) may exist in a cloud server and the like provided in the network 172. According to this configuration, it is possible to connect the necessary number of robots 160′ to the machine learning device 120 (or the machine learning device 100) as necessary, regardless of where and when each of the plurality of robots 160′ is located.

At an appropriate time after starting learning by the machine learning device 120 (or 100), the operator engaged in the system 170 (FIG. 7) or the system 170′ (FIG. 8) can determine whether or not a degree of the learning achievement (that is, the reliability of the machining condition (tool information S3, the feed rate S4, and the rotational speed S5) to be output) of the machining condition (tool information S3, the feed rate S4, and the rotational speed S5) by the machine learning device 120 (or the machine learning device 100) has reached a required level.

Even though the present invention has been described above, the present invention is not limited only to examples of the above-described embodiments, and can be implemented in various modes by making appropriate changes.

For example, the learning algorithm executed by the machine learning device 100 and the machine learning device 120, the arithmetic algorithm executed by the machine learning device 120, the control algorithm executed by the controller 1 or the controller 2, and the like are not limited to those described above, and various algorithms is adaptable.

Also, in the embodiments described above, the controller 1 (or the controller 2) and the machine learning device 100 (or the machine learning device 120) are described as those having different CPUs, but the machine learning device 100 (or the machine learning device 120) may be configured to be implemented by the CPU 11 provided in the controller 1 (or the controller 2) and the system program stored in the ROM 12.

Also, in the embodiments described above, it is considered that the controller 1 (or the controller 2) and the machine learning device 100 (or the machine learning device 120) are one locally installed information processing apparatus, but the embodiments are not limited thereto. For example, the controller 1 (or the controller 2) and the machine learning device 100 (or the machine learning device 120) may be implemented in an information processing environment referred to as cloud computing, fog computing, edge computing, and the like.

1. A controller for controlling a robot performing deburring by removing a burr from a workpiece, comprising:
a machine learning device for learning machining conditions when the deburring is performed,
wherein the machine learning device includes
a state observing unit for observing workpiece information indicating at least one of a shape or a material of the workpiece, burr information indicating at least one of a shape or a position of the burr, and machining conditions including tool information indicating a type of a tool, a feed rate of the tool and a rotational speed of the tool, as a state variable representing a current state of an environment,
a determination data acquiring unit for acquiring determination data indicating an evaluation result of the deburring, and
a learning unit for performing learning by associating the machining conditions with the workpiece information and the burr information, using the state variable and the determination data.

2. The controller according to claim 1,
wherein the determination data includes at least one of a removal rate of the burr, or a cycle time of the deburring.

3. The controller according to claim 1,
wherein the learning unit includes a reward calculating unit for obtaining a reward related to the evaluation result, and a value function updating unit for updating a function representing values of the machining conditions with respect to the workpiece information and the burr information using the reward.

4. The controller according to claim 1,
wherein the learning unit calculates the state variable and the determination data with a multilayered structure.

5. The controller according to claim 1, further comprising a decision making unit for outputting a command value based on the machining conditions, based on a learning result by the learning unit.

6. The controller according to claim 1,
wherein the learning unit learns the machining conditions using the state variable and the determination data obtained from a plurality of the robots.

7. The controller according to claim 1,
wherein the machine learning device is implemented by cloud computing, fog computing, and edge computing environment.

8. A machine learning device for learning machining conditions when a robot performs deburring for removing a burr from a workpiece, comprising:
a state observing unit for observing workpiece information indicating at least one of a shape or a material of the workpiece, burr information indicating at least one of a shape or a position of the burr, and machining conditions including tool information indicating a type of a tool, a feed rate of the tool and a rotational speed of the tool, as a state variable representing a current state of an environment;
a determination data acquiring unit for acquiring determination data indicating an evaluation result of the deburring; and
a learning unit for performing learning by associating the machining conditions with the workpiece information and the burr information, using the state variable and the determination data.
